(19) United States
(12) Patent Application Publication
(10) Pub. No.: US 2004/0011972 A1
(43) Pub. Date: Jan. 22, 2004

(54) Device for shielding against radiation

(76) Inventor: Ali Alishahi, Wien (AT)

Correspondence Address: YOUNG & THOMPSON, 745 SOUTH 23RD STREET 2ND FLOOR, ARLINGTON, VA, 22202

(21) Appl. No.: 10/258,135

(22) PCT Filed: Apr. 19, 2001
(86) PCT No.: PCT/AT01/00117

(51) Int. Cl. G21F 1/00

(52) U.S. Cl. 250/515.1

(57) ABSTRACT

In order to protect or shield the human body from the effect of carcinogenic waves or radiation energy and to treat said body, the invention provides a device comprising a wall structure (13, 32, 14, 15) which surrounds a chamber that is to be shielded against the radiation. The wall structure (13, 32, 14, 15) forms a spherical enclosure (3) which is located underground (12).

The invention relates to a device for shielding against radiation with a wall structure which surrounds a space which is to be shielded against the radiation.

This invention proceeds from the theory of formation of cancer cells that the entire human body, its cells and its genes in the age of technology are always under the influence of carcinogenic waves or radiation energy. Each pair of the total of 23 chromosome pairs of a healthy cell is composed of a positive and negative part. These parts join during cell division and form a new cell. Due to the aforementioned carcinogenic waves or radiation energy it can happen that this joining does not proceed normally and after cell division it happens that in a cell solely positive or negative chromosomes are joined. They begin to divide increasingly in the search for the correct counterpart and form a tumor, the so-called cancer. Due to this increased production of new cells the entire immune system is weakened. Cell proliferation causes continuous weakening of the stem cells. The cell membrane becomes filigree and more permeable and thus more receptive to radiation. Consequently the diseased cells take more and more energy and nutrients from the entire body, by which the body is additionally weakened; this can lead to death.

In order to treat patients over individually established time intervals they should be protected entirely from the action of carcinogenic radiation. Furthermore, diversion of endogenous positive body waves should take place.

As soon as the cause of the overstimulation caused by radiation is eliminated, regular cell division takes place again. The proliferation of diseased cancer cells is checked and the immune system is relieved and thus strengthened such that at least stagnation and subsequently decomposition of already present malignant tumors take place. At the same time the cell membrane is built back up again and is moreover also resistant.

DE 40 25 403 A1 discloses a generic device which has a grid-shaped metal skeleton for shielding against electromagnetic fields and radiation, to which tabular metallic elements are attached. The space formed in this way has a cubic shape.

For purposes of the present invention this device does not have the required high shielding against radiation.

In order to achieve very high shielding against radiation, a device for shielding against radiation with a wall structure which surrounds a space which can be shielded against radiation is proposed, which is characterized in that the wall structure forms a spherical jacket which is located underneath the earth's surface.

Extremely efficient shielding against radiation is achieved by the spherical execution of the jacket and its arrangement underneath the earth's surface. By means of the device as claimed in the invention, the excess positive potential in the cells is furthermore absorbed and at the same time the negative potential is increased. In this way the channels of the cell walls and the nuclear membrane and also the small nuclear wall are entirely or almost entirely closed. This means that the cells can no longer divide uncontrolled, by which the body regenerates, tumors are broken down, and cancer is cured.

To protect and cure the patient, he is placed in the space of the device which is sealed airtight and is shielded from the outside against any radiation. The patient is kept here in the center of the space over a time interval which is dependent on the stage and type of the disease, without reaching only into the vicinity of the walls. Cell growth and the course of the disease can be observed and evaluated under continuous physician supervision.

Preferred embodiments of the invention are the subject matter of the dependent claims.

One preferred embodiment of the invention is described below with reference to the attached drawings.

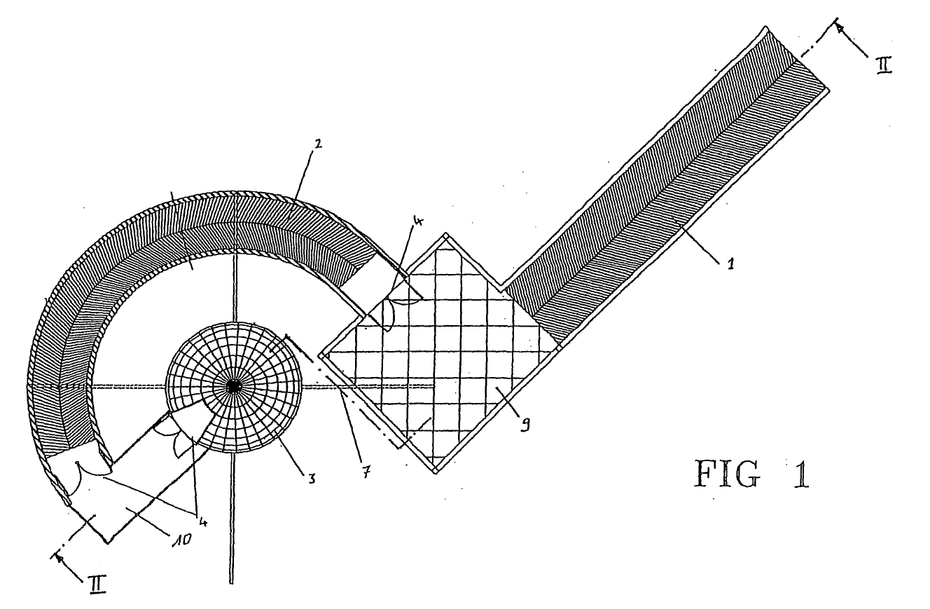

FIG. 1 shows an overhead view of the device as claimed in the invention,

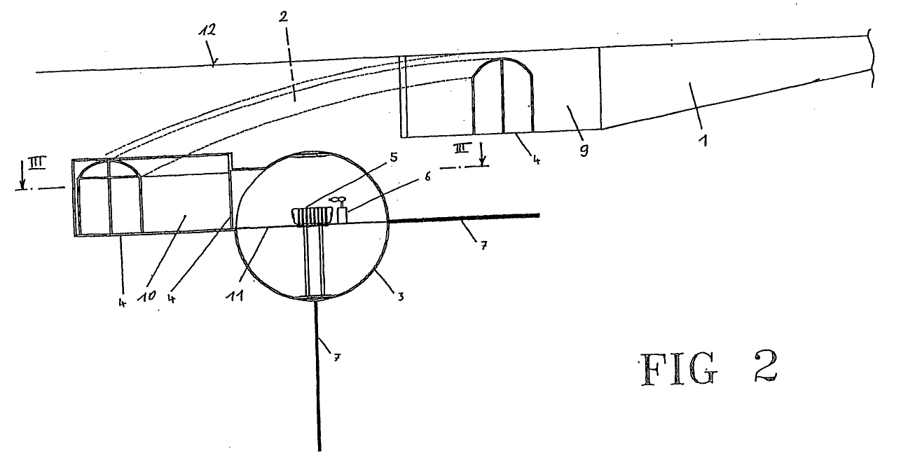

FIG. 2 shows a section through the device from FIG. 1 along line II-II,

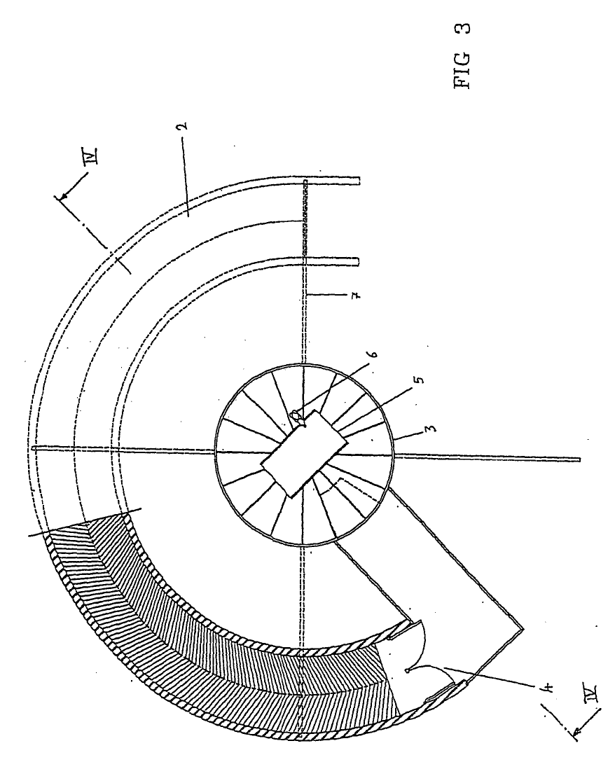

FIG. 3 shows a section through the device along line III-III in FIG. 2,

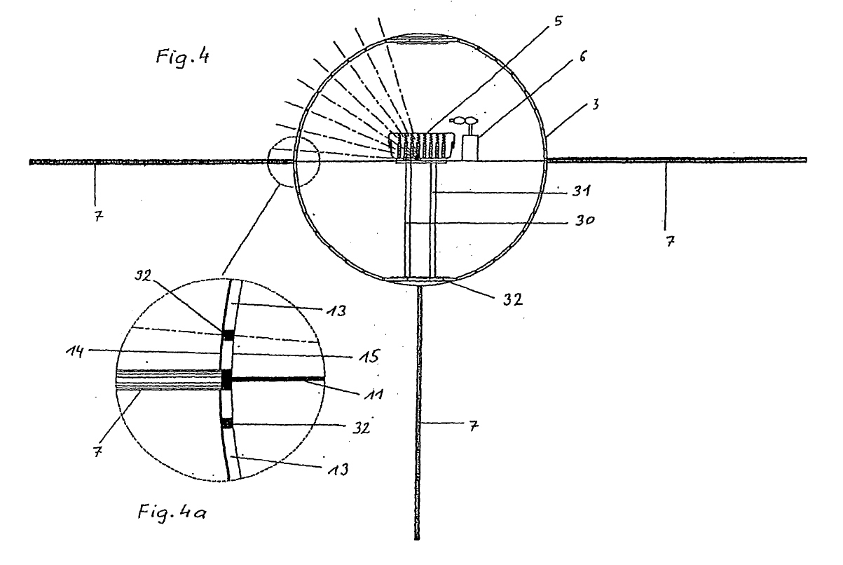

FIG. 4 shows a section through the device along line IV-IV in FIG. 3, in any case without a passage,

FIG. 4a shows a detail from FIG. 4,

FIG. 5 shows an oblique view of the structure of the device,

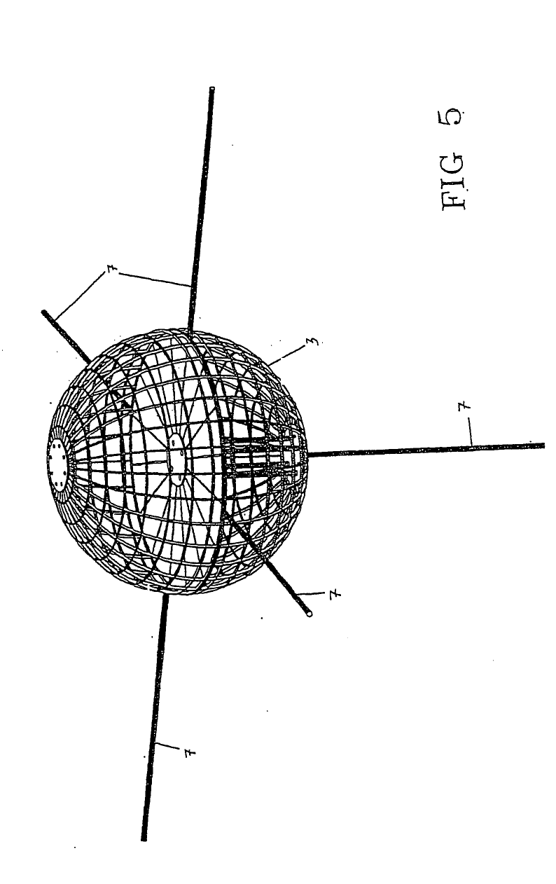

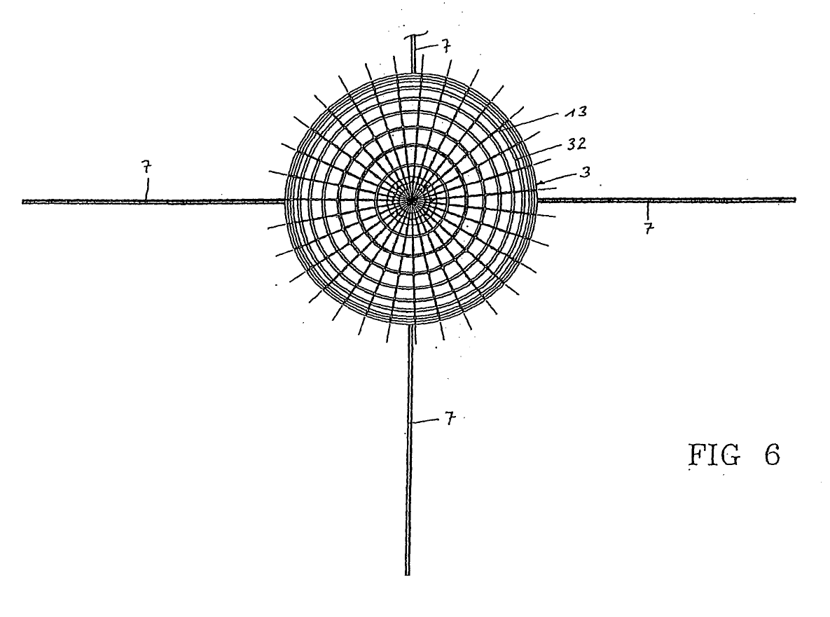

FIG. 6 shows an overhead view of the structure from FIG. 5,

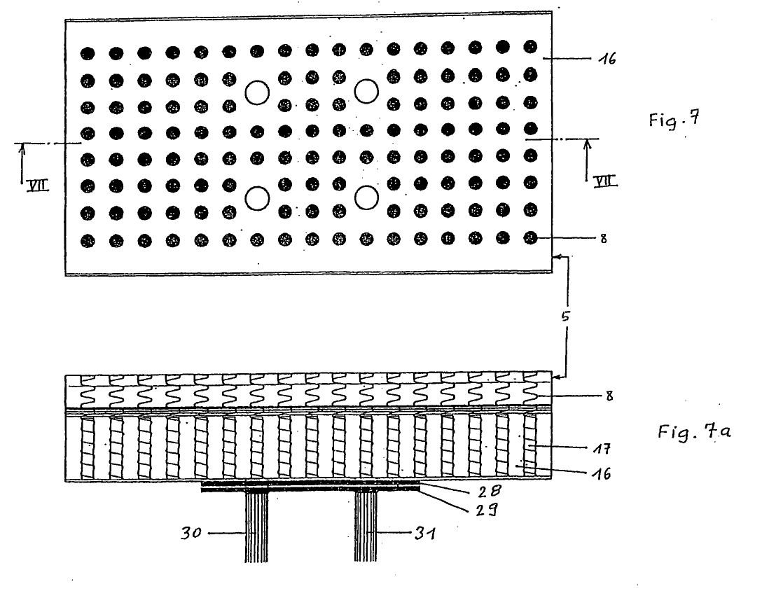

FIG. 7 shows an overhead view of the structure of the bed of the device as claimed in the invention;

FIG. 7a shows a section along line VII-VII in FIG. 7,

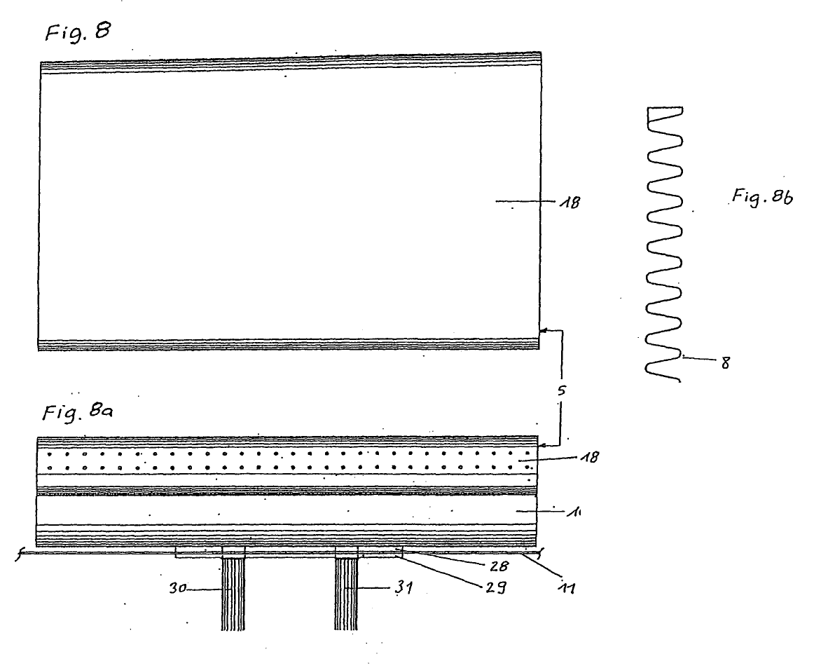

FIG. 8 shows an overhead view of the bed,

FIG. 8a shows a side view of the bed,

FIG. 8b shows a spring of the bed,

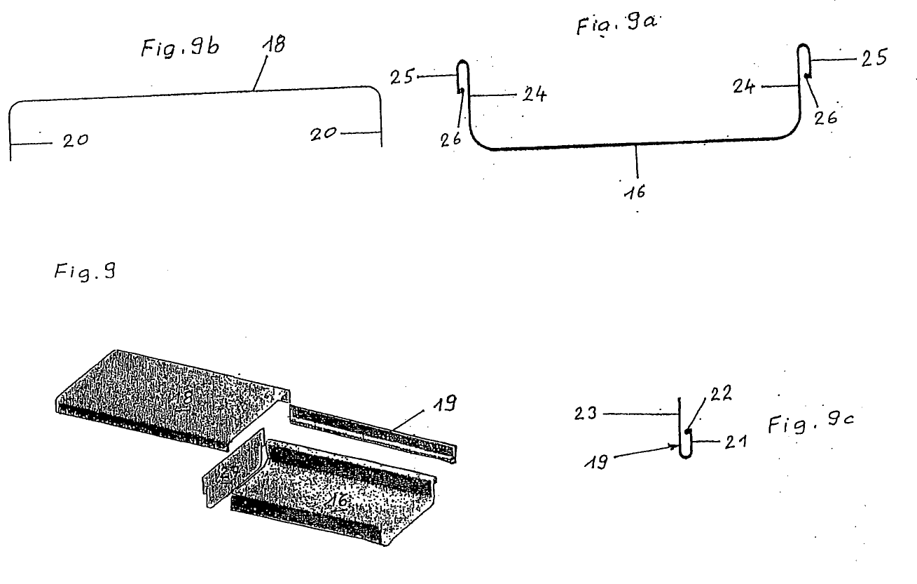

FIG. 9 shows an exploded view of the bed,

FIG. 9a shows a front view of the trough of the bed,

FIG. 9b shows a front view of the cover of the bed and

FIG. 9c shows a front view of a side part of the bed,

FIG. 10 shows an oblique view,

FIG. 10a shows a side view,

FIG. 10b shows an overhead view and

FIG. 10c shows a development of the wall part of the spherical jacket of the device,

FIG. 11a shows a vertical section,

FIG. 11b shows an overhead view,

FIG. 11c shows a side view of a bar of the framework of the spherical jacket of the device,

FIG. 12 shows an oblique view of the sphere of the device as claimed in the invention, but without the passage,

FIG. 13 shows another embodiment of the device as claimed in the invention in an overhead view,

FIG. 14 shows a vertical section of the device from FIG. 13,

FIG. 15 shows a third embodiment of the device as claimed in the invention,

FIG. 16 shows a vertical section of the device from FIG. 15,

FIG. 17 shows an overhead view of the straight passage which leads into the sphere of the device as claimed in the invention,

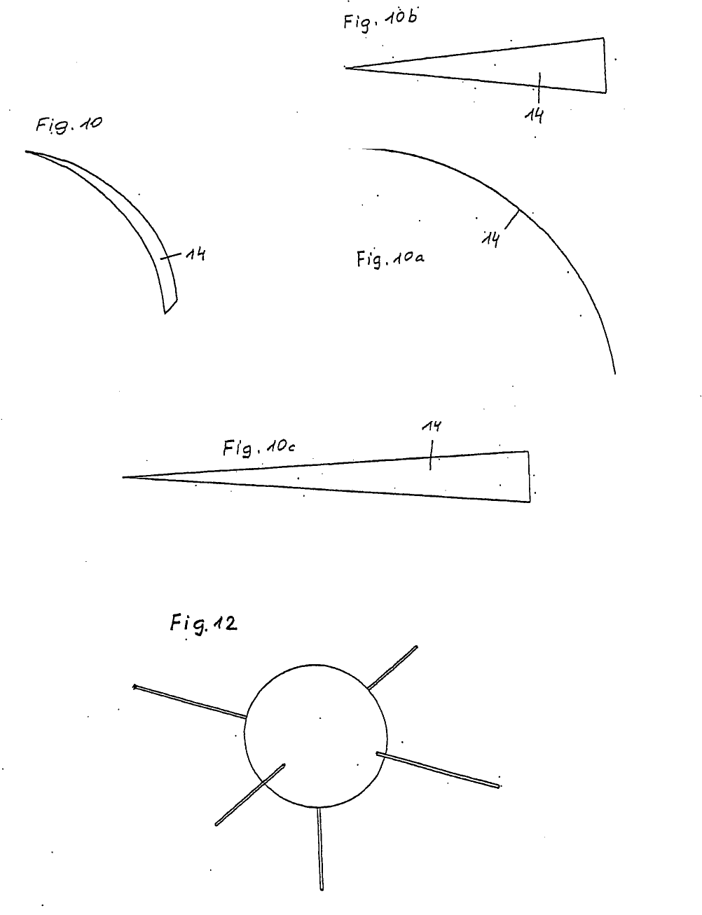

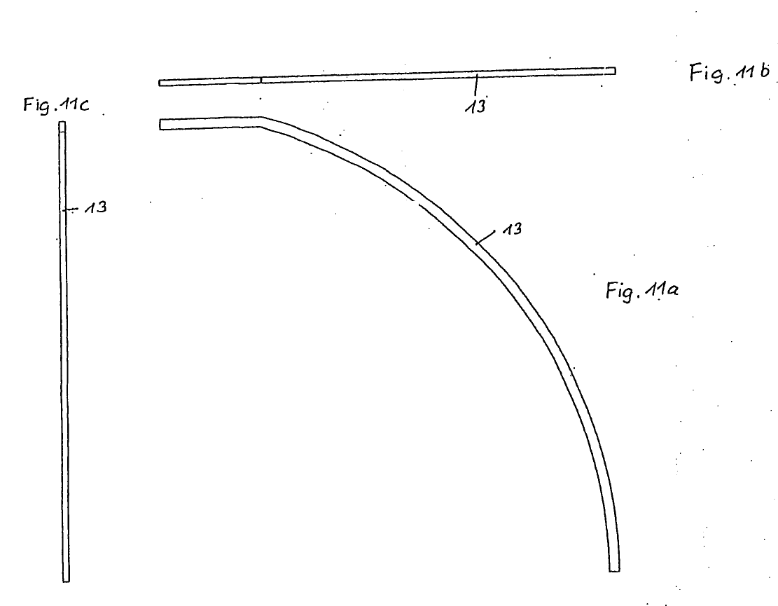

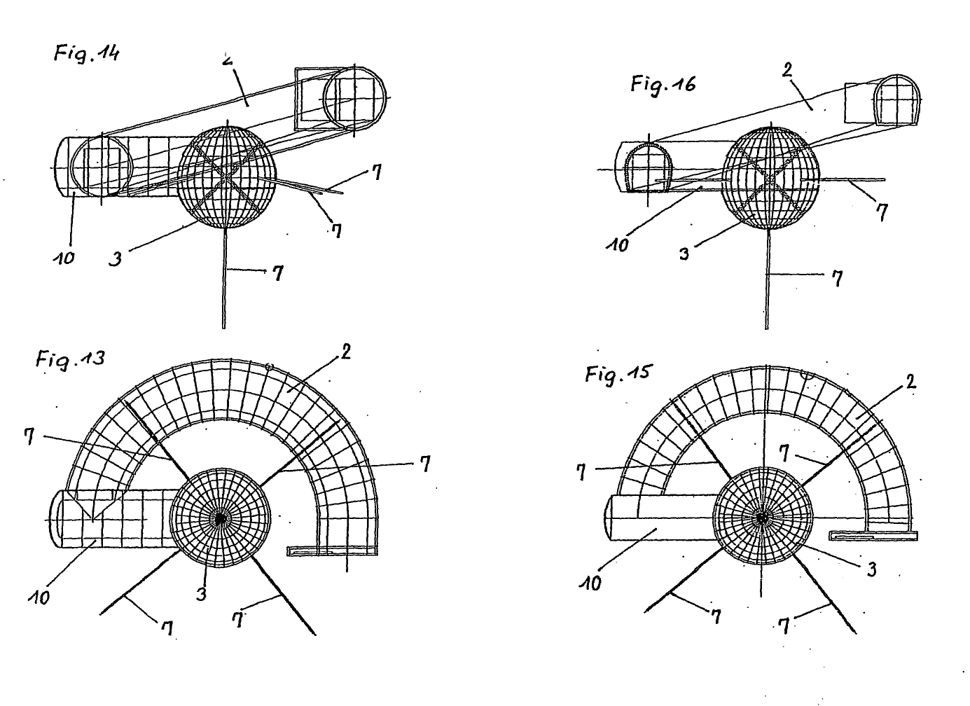

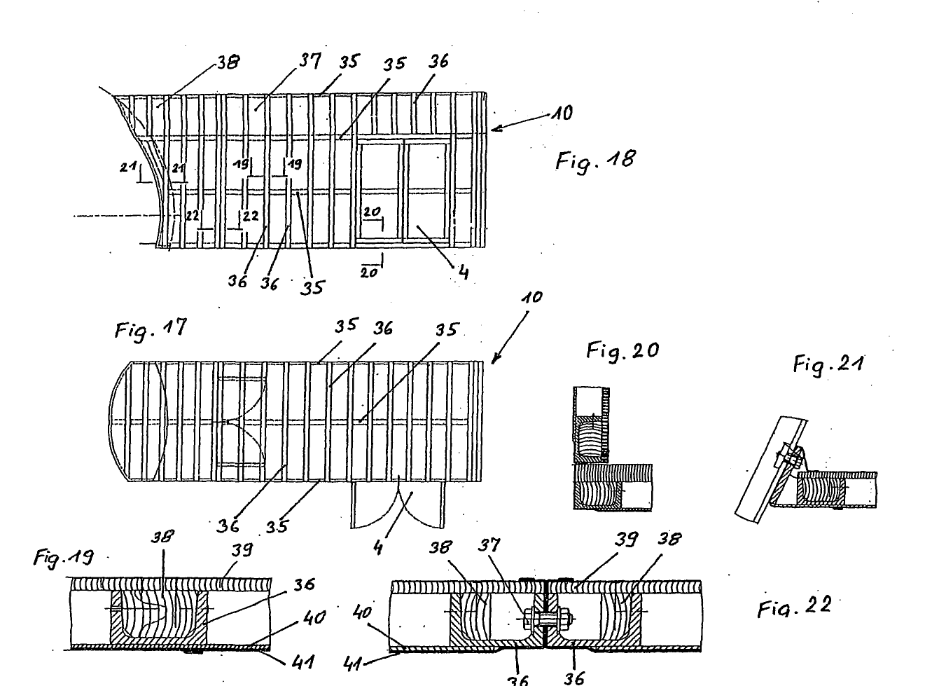

FIG. 18 shows a vertical section of the passage from FIG. 17,

FIGS. 19 to 22 show details of the passage from FIGS. 17 and 18,

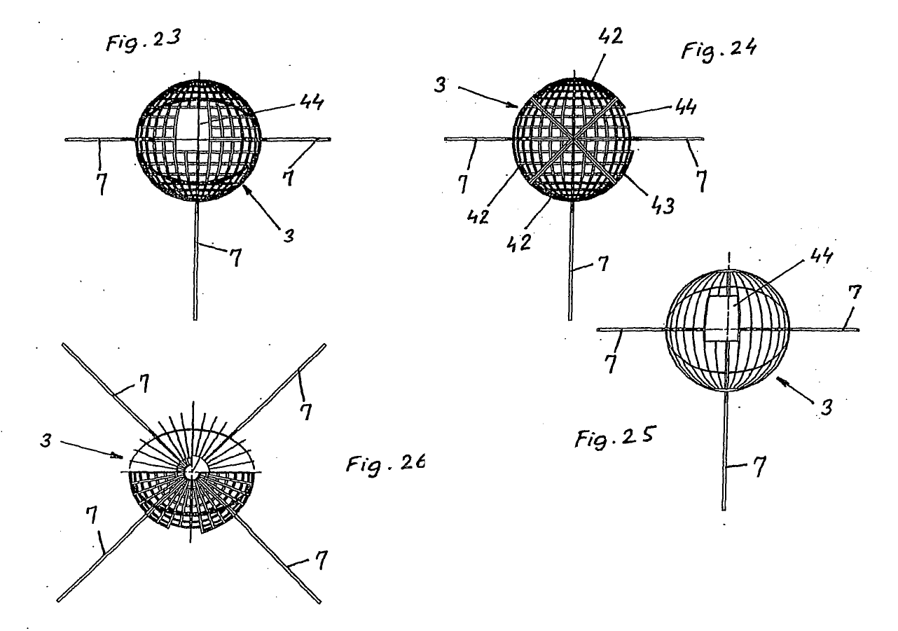

FIG. 23 shows a vertical section of the sphere from the side of the entry,

FIG. 24 shows a side view of the sphere from FIG. 23,

FIG. 25 shows a view according to FIG. 23 in which only part of the lattice structure can be seen,

FIG. 26 shows an overhead view of FIG. 23 in which likewise only part of the lattice structure can be seen,

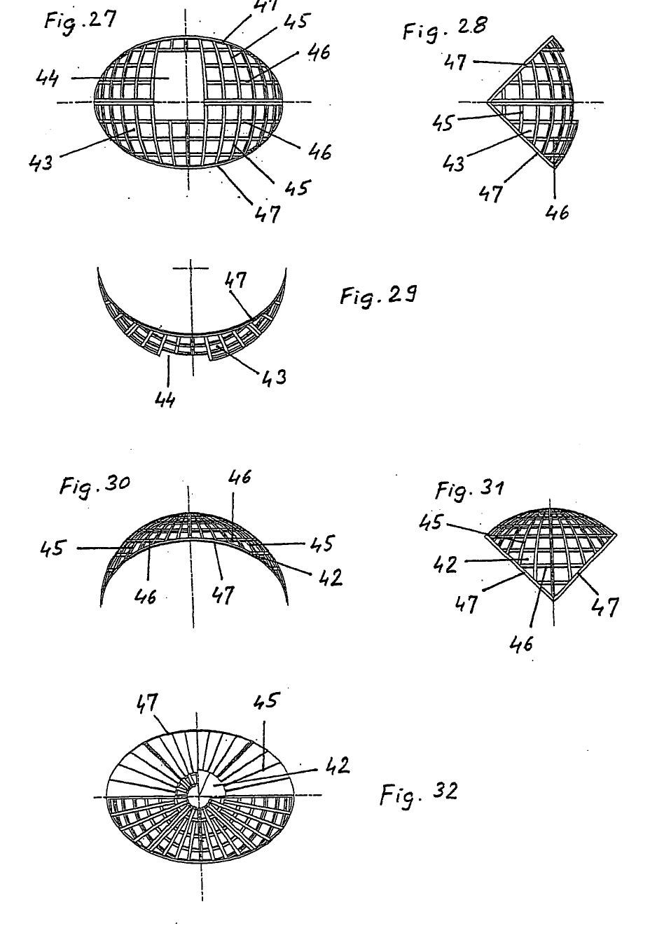

FIG. 27 shows a vertical section of a segment of the ball,

FIG. 28 shows a side view of the segment from FIG. 27,

FIG. 29 shows an overhead view of the segment from FIG. 27,

FIG. 30 shows another segment of the sphere in a vertical section,

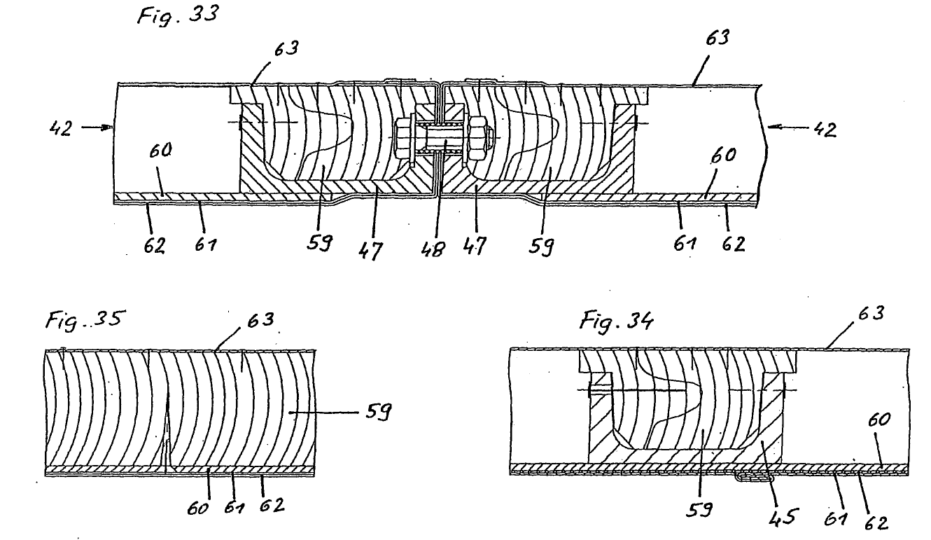

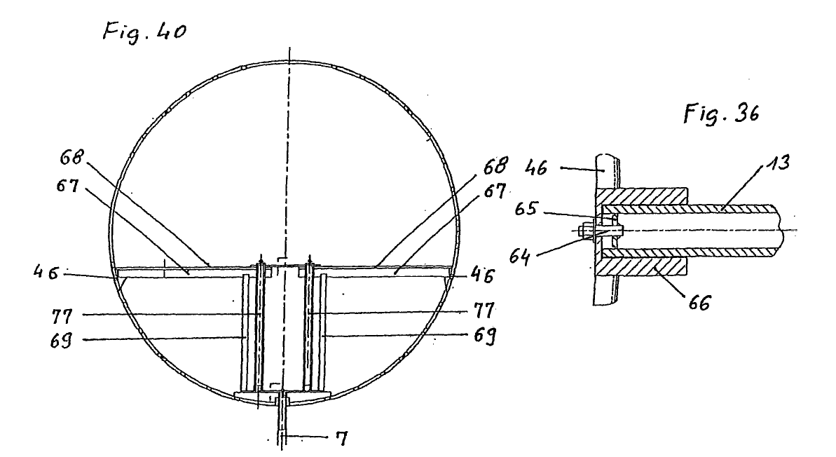

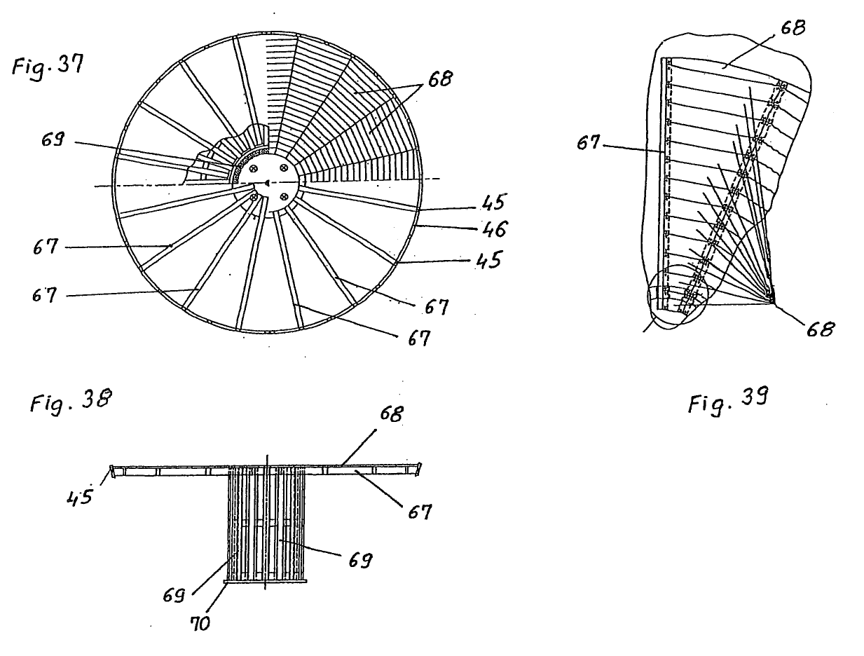

FIG. 31 shows a side view of the segment from FIG. 30,

FIG. 32 shows an overhead view of the segment from FIG. 30,

FIG. 33 shows the connection of segments of the sphere in a section,

FIG. 34 shows a section through a segment in the area of one lattice bar,

FIG. 35 shows a section through a segment in the area of insulation,

FIG. 36 shows a section through the attachment of the outside bar to one segment,

FIG. 37 shows the wooden floor located in the sphere in an overhead view,

FIG. 38 shows a vertical section of the floor from FIG. 37,

FIG. 39 shows details of the floor as shown in FIGS. 37 and 38,

FIG. 40 shows a section through the sphere,

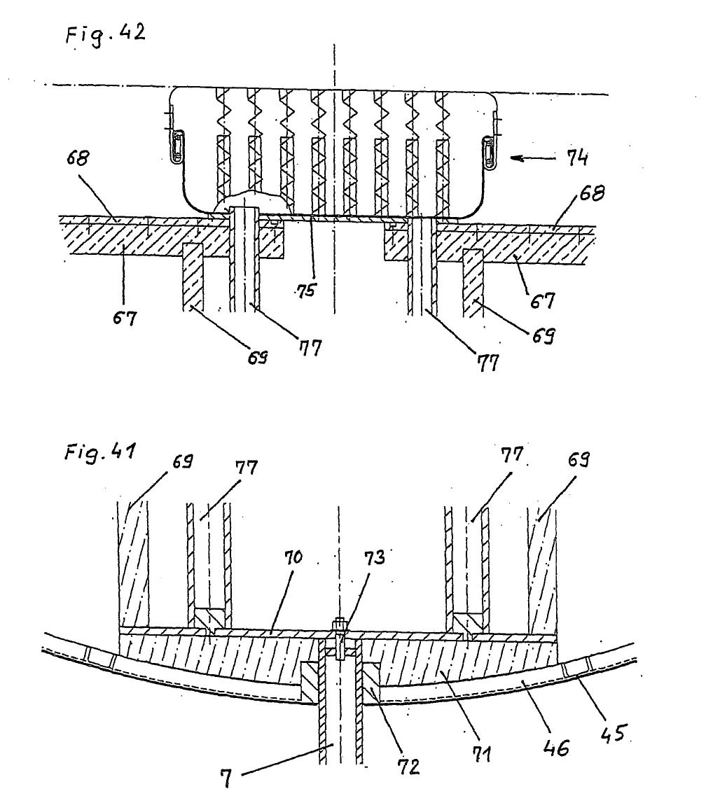

FIG. 41 shows a section through the floor area of the ball,

FIG. 42 shows a section through the floor in the area of a bed,

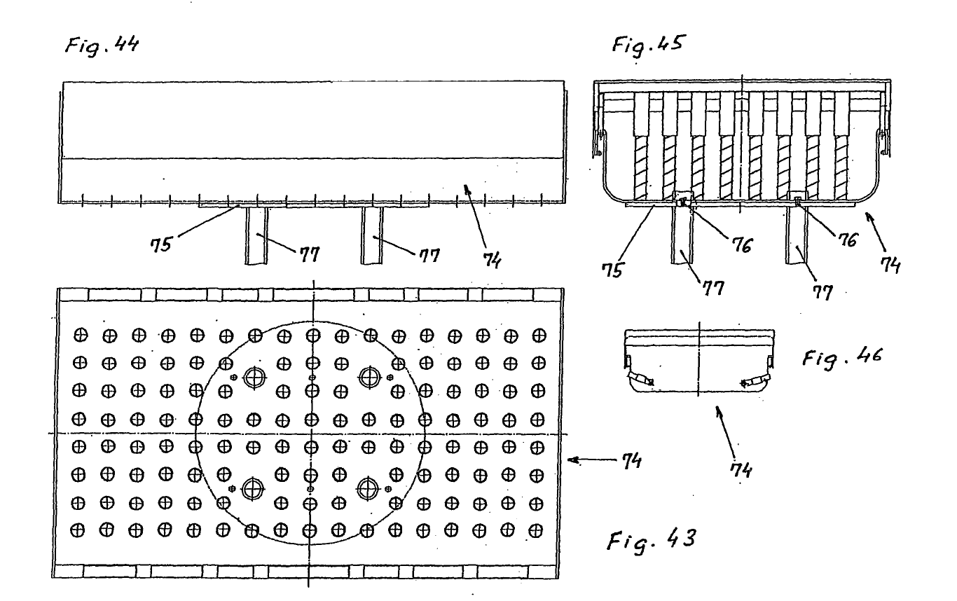

FIG. 43 shows an overhead view of another embodiment of a bed,

FIG. 45 shows a side view of the bed,

FIG. 46 shows a cross section through the bed and

FIG. 47 shows a front view of the bed on a reduced scale.

The device as claimed in the invention consists essentially of a spherical hollow body 3 with an outside diameter of 5 m which is accessible over an elongated passage 1, an intermediate space 9, a passage 2 curved in an arc-shape and another straight passage 10. The passage curved in an arc-shape 2 can be closed on its ends by two doors 4 and the entry between the straight passage 10 and the sphere 3 can likewise be closed by means of a door.

Within the sphere 3 there is a floor plate 11 which extends through the center of the sphere 3 and is located at a level of 5.49 m under the earth's surface 12 (FIG. 2). The floor plate consists of copper and is 10 mm thick. The passage 1 and the passage 2 are tilted as can be seen in FIG. 2, the floor in the intermediate space 9 being located at a level of 2.7 m under the earth's surface 12. The sphere is located under the earth such that the highest point of the sphere is at least 3 m under the earth's surface 12. The earth's surface 12 should be planar and the composition of the soil should have a high proportion of clay.

The sphere has a lattice-like structure of bars 13 which are welded to one another and which consist of 99.99% anodic copper and are 3×5 cm thick (FIG. 11). The bars 13 of the lattice-like structure of the sphere are connected via arc-shaped bars 32. Plates 14 of 99.99% anodic copper with a thickness of 3 mm are welded to this lattice structure and are coated with a layer 0.15 mm thick consisting of 98.5% pure silver and 1.5% palladium. On the inside a jacket 15 of 99.99% anodic copper with a thickness of 0.1 is applied (FIG. 4a).

Five bars 7 which are 5 m long are welded to the lattice-shaped structure of the sphere laterally and to the bottom.

Within the sphere, roughly in its center there are a bed 5 which is built as described in FIGS. 7 to 9 and a device 6 for supplying a patient. The bed 5 has a trough 16 in which there are helical springs 9 wound around the bars 17 and which project over the bars 17. A cover 18 lies on the springs 8 and its edges 20 which are bent down are connected to side parts 19 which are bent in a U-shape. The shorter leg 21 of the side parts 19 has a reinforced edge which is bent toward the longer leg 23. The side walls 24 of the trough 16 likewise have sections 25 which are bent to the outside by 180° with edges 26 which are bent toward the side walls and are reinforced.

The cover 18 with the side parts 19 can be pushed according to length onto the trough 16 such that the side parts 19 and the side walls 24 hook into one another and allow vertical play of the cover 18 relative to the trough 16 so that the cover 18 can spring down, supported by the springs 8, when a patient lies on the cover 18. The trough is closed by the end walls 27, as shown in FIG. 9.

The bed 5 consists of anodic copper which is coated with gold so that no inflammation of the patient occurs and direct transmission of negative waves takes place. The springs 8 consist of bronze and are coated with silver for a good connection.

On the bottom of the trough 16 there are two copper disks 28 and 29 with a thickness of 20 mm, between which the floor plate 11 is located. From the lower copper plate 29 vertical uprights 30 and 31 extend down and in the area of the lower end of the sphere 3 rest on the platform 32 of the lattice structure of the sphere 3 (FIG. 4).

The embodiments of the device as claimed in the invention shown in FIGS. 13 and 14 as well as 15 and 16 consist in turn of a spherical hollow body 3 which is accessible via a passage 2 which is curved in an arc-shape and another passage 10. In the embodiment as shown in FIGS. 13 and 14 the passages 2 and 10 are made ring-shaped, with a flat running surface 33, and in the embodiment from FIGS. 15 and 16 in a tunnel form with a likewise flat running surface 34.

The passage 10 in the embodiment as shown by FIGS. 17 to 22 consists of a lattice structure with lengthwise bars 35 and cross bars 36 of iron, the latter being matched to the cross sectional shape of the tunnel 10. The tunnel 10 is composed of segments 37 and 38, the end-side adjoining cross bars 36, as shown by FIG. 22, are interconnected via a screw connection 37. The rods 35 and 36 have a U-shaped cross section, and between their legs and between the bars 35 and 36 insulation 39 can be attached. On the inside the passage is lined with wood 39. On the outside are for example iron plates 40 with insulation 41.

But likewise it is also possible to produce the passage 10 from reinforced concrete, for example in the form of prefabricated reinforced concrete parts and to attach a lining of wood 39 on the inside and insulation 41 outside.

As shown by FIGS. 23 to 32, the sphere 3 consists of an essentially lattice-shaped structure which in this embodiment is made for example of four segments, three segments 42 being made largely identical, conversely in the fourth segment 43 there is an opening 44 connected to the passage 10. The segments 42 and 43 have lattice bars 45 and 46 and edge bars 47 of iron, the lattice bars 46 being located roughly horizontally, conversely the lattice bars 45 being arranged running roughly at a right angle thereto.

FIG. 33 shows the connection of two segments 42 which are located next to one another. The segments 42 adjoin one another on their edge bars 47 and are screwed to one another by means of screws 48. Between the U-legs of the edge bars 47 which are built essentially identically to the lattice bars 45 and 46, there is insulation 59. Insulation 59 can be placed between the edge bars 47 and the other lattice bars 45 and 46, as shown in FIG. 35.

The outside wall of segments 42 and 43 consists, as is especially shown in FIGS. 33 to 35, of iron plates 60 with a thickness of for example 3 mm, adjoining insulation 61 of for example 1 mm, and another layer of copper plate 62 with for example a 1 mm thickness. The copper plate 62 is silver-coated with a thickness of 15 microns and the silver is further gold-plated with a thickness of 5 microns. On the inside the segments 42 and 43 have a copper plate 63. The inside walls can furthermore have a wood lining.

As FIG. 33 shows, the insulation 61 and the outer copper plate 62 are bent around the end face of each segment 42 and are connected to the inner copper plate 63.

FIG. 36 shows that the bars 13 can be connected to the segments 42 via sleeves 66, the sleeves 66 for their part being connected, for example welded, to the lattice bars 45 and 46. The bars 13 are inserted into the sleeves 66 and screwed or clamped to the sleeves 66 via washers 65 which fit into the interior of the bars 13, and screws 64.

FIGS. 37 to 42 show the floor of the device as claimed in the invention in a version of wood. It consists essentially of beams 67 which are arranged in a star-shape and to which boards 68 are attached. The beams 67 in the area of their inner ends rest on a cylindrical structure of wooden uprights 69 and are attached on their outer ends to the lattice bars 45 and 46. The uprights 69 can be located either closely adjoining one another, as shown in FIG. 37, or with a distance from one another, as shown by FIGS. 38 and 40.

The wooden uprights 69 are supported on plates 70 and 71 which are located in the lower area of the sphere, as shown in FIG. 41. FIG. 41 furthermore shows how a bar 13 extends through the sleeve 72 located in this area and is screwed to the plate 70 by means of a screw 73.

FIGS. 42 to 46 show an embodiment of a bed 74 which is somewhat modified relative to FIGS. 8 and 9 and which is attached to one plate 75 by means of screws 76. The plate 75 lies on the boards 68 of the floor. The bed 74 is furthermore connected to the plate 70 in the area of the lower end of the sphere via four metal uprights 77.

1. Device for shielding against radiation with a wall structure which surrounds a space which is to be shielded against the radiation, characterized in that the wall structure (13, 32, 4, 15) forms a spherical jacket (3) which is located underneath the earth's surface.

2. Device as claimed in claim 1, wherein there is a bed (5, 74) which is located roughly in the center of the spherical space.

3. Device as claimed in claim 1 or 2, wherein the wall structure is connected to five bars (7), wherein four bars (7) are located roughly in one plane and on axes which intersect one another roughly at a right angle and which are located roughly horizontally, wherein the fifth bar (7) points vertically down from the jacket (3) and is located on an axis which is aligned to the plane of the four first bars (7) at a right angle, and wherein the axes (7) intersect in the center of the jacket (3).

4. Device as claimed in claim 2 and 3, wherein in the plane of the bars (7) within the jacket (3) there is a floor plate (11) to which the bed (5, 74) is attached.

5. Device as claimed in one of claims 2 to 4, wherein the bed (5, 74) consists of a trough (16) and a cover (18), the cover (18) being supported via springs (8) on the trough (16).

6. Device as claimed in claim 5, wherein the trough (16) and the cover (18) consist of gold-plated copper.

7. Device as claimed in claim 5, wherein the springs (8) consist of bronze and are coated with silver.

8. Device as claimed in one of claims 1 to 7, wherein the wall structure consists of a lattice-like structure of bars (13, 32; 45, 46, 47).

9. Device as claimed in claim 8, wherein the lattice-like structure on its outside is provided with copper plates (14) which are coated with a layer of silver and palladium and on its inside with copper plates.

10. Device as claimed in one of claims 1 to 9, characterized by a passage to the spherical jacket (3), with a section (2) which extends in the shape of an arc around the spherical jacket (3) and a straight section (10) which extends radially to the spherical sleeve (3) and the latter opens.
